(19) United States
(12) Patent Application Publication
(10) Pub. No.: US 2018/0094669 A1
(43) Pub. Date: Apr. 5, 2018

(54) SNAP-IN MOUNTING FOR MOUNTING AN ENGINE TOP COVER

(71) Applicant: Autoneum Management AG, Winterthur (CH)

(72) Inventors: Christian Müller, Winterthur (CH); Wenzel Krause, Winterthur (CH); Laurent Mirouze, Parmain (FR)

(21) Appl. No.: 15/566,673

(22) PCT Filed: Apr. 14, 2016
(86) PCT No.: PCT/EP2016/058195

§ 371 Date: Oct. 13, 2017

(30) Foreign Application Priority Data
Apr. 15, 2015 (EP) 15163754.3

(51) Int. Cl. F16B 21/07; B60R 13/08; F02F 7/00

(52) U.S. Cl. CPC F16B 21/073; F02B 77/13; F02F 7/0085; B60R 13/0838

(57) ABSTRACT

The present invention is directed to a snap-in mounting for mounting a top cover onto the engine of a motor vehicle, the top cover with the snap-in mounting, a mounting system with the snap-in mounting and a male part and a method of producing the snap-in mounting. The snap-in mounting for mounting a top cover onto the engine of a motor vehicle according to the invention comprises a female part including, a receiving part, which is adapted to receive the ball-shaped end of a male part by a snap-in connection, and a holding part for holding the receiving part, wherein the receiving part and the holding part are, preferably, separate parts, wherein the holding part is adapted to be fixed to the top cover's bottom side, which faces the engine of a motor vehicle when mounted, wherein the holding part, preferably, has a sliding portion, which is adapted to allow for a relative displacement of the receiving part and the holding part by a sliding motion, wherein the receiving part is moulded from a polymer material containing at least a thermoplast.

### TECHNICAL FIELD

The present invention is directed to a snap-in mounting for mounting a top cover onto the engine of a motor vehicle, the top cover with the snap-in mounting, a mounting system with the snap-in mounting and a male part, a moulding device for producing the snap-in mounting and a method for producing the snap-in mounting.

### BACKGROUND

Snap-in mountings for mounting a top cover onto the engine of a motor vehicle are generally known in the prior art. Known plug-in couplings have a female part and a male part, the male part having a ball-shaped end, which is inserted into the female part by a snap-in connection so as to be positively retained therein. Many known snap-in mountings contain a decoupler for acoustically decoupling vibrations of the engine from being transferred to the top cover and thereby being emitted as noise. The deformability and elasticity of a decoupler made from an elastomer not only serves for acoustically decoupling but also for allowing a deformation of the decoupler for realizing a snap-in. However, the overall construction of the plug-in coupling having an elastomeric decoupler has a relatively large mass and using an elastomer leads to relatively high production costs. Both drawbacks are undesired by the car industry, where a general need for light-weight products and cost-saving productions exists.

The technical problem underlying the present invention is to provide a light-weight and mechanically reliable snap-in mounting and a method for producing the same, which is cost-saving.

### SUMMARY OF THE INVENTION

The problem is solved by the snap-in mounting according to claim 1, the top cover with the snap-in mounting according to claim 12, a mounting system with the snap-in mounting and a male part according to claim 14, a method of producing the snap-in mounting according to claim 15 and the moulding device according to claim 17.

Preferably, the snap-in mounting is configured such that the receiving part and the holding part are separate parts. This offers the advantage that the holding part can be configured to be capable to hold at least a first receiving part and at least a second receiving part, wherein the at least first receiving part and the at least a second receiving part are shaped differently, in particular using a first thermoplast for moulding the first receiving part and a second thermoplast for moulding the second receiving part, respectively. The first and second thermoplast can be the same. The first and second thermoplast can be different.

This way, one and the same kind of holding part may be used in combination with different receiving parts, thereby creating a modular system, which is flexible and can be most efficiently applied. The end of a male part, preferably, is ball-shaped. Preferably, the at least one first receiving part is configured to receive the end of a first type of a male part, the at least one second receiving part is configured to receive the end of a second type of a male part. The first type of a male part may have a ball-shaped end having a first diameter; the second type of a male part may have a ball-shaped end having a second diameter, wherein the first diameter and the second diameter are different. This way, one and the same type of holding part can be used with different types of receiving parts, which in particular differ with respect to the dimension, e.g. the diameter, of the ball-receiving portion of the receiving part.

Preferably, the holding part has a sliding portion, which is adapted to allow for a relative displacement of the receiving part and the holding part by a sliding motion. Such a snap-in mounting is self-centering due to the relative mobility of the receiving part and the holding part, which are configured for performing a relative sliding motion at the sliding portion. The capability for sliding is achieved by using the polymer material containing the thermoplast, which also provides for a light-weight construction, in particular compared to an elastomer, desirable mechanical properties regarding abrasion, and allows for a low-cost production.

It is also possible and preferred that the receiving part and the holding part are formed integrally or are immovably connected to each other, either directly or via at least one connection element. This way, producing the snap-in mounting is particularly cost-saving.

Preferably, the receiving part has a funnel-shaped receiving portion, which includes a funnel-shaped inner volume, and preferably a ball receiving portion, which includes a ball-receiving inner volume, which is preferably substantially ball-shaped. For the purpose of establishing the snap-in connection by moving the receiving portion and the male part toward each other, the funnel-shaped portion is adapted to guide the ball-shaped end of the male part along the funnel-shaped inner surface into the ball receiving portion preferably substantially having a ball-shaped inner surface. In the coupling position, the ball receiving portion and the ball-shaped end of the male part act as a ball-and socket joint for movably coupling the female part and the male part. Preferably, the funnel-shaped receiving portion is formed to allow tilting of the male part within the limits of the funnel, in the coupling position. The end of the male part, preferably, is ball-shaped, but may generally also have another shape, which allows for snap-in of the end of the male part in the corresponding receiving portion of the female part.

The receiving part, in particular the funnel-shaped receiving portion and/or the ball receiving portion, preferably, has at least one click wall, which is arranged and shaped to be displaced by elastically bending under the force provided by inserting the ball-shaped end of the male part—preferably through the funnel-shaped receiving portion—into the ball receiving portion, such that the at least one click wall supports and retains the male part at the receiving part by engaging the undercut provided at the ball-shaped end of the male part. The elastic bending is achieved, in particular, by using the at least one thermoplast for the polymer material when moulding the receiving part. The click wall serves to support and retain the ball-shaped end of the male part, when it is inserted into the ball receiving portion in the coupling position of the female part and the male part. The at least one click wall is advantageously formed by injection moulding such that no undercut is generated at the receiving part when moulding the receiving part as one piece using an injection moulding device with two opposing mould forms, which in between define the negative contour of the receiving part. Undercuts on moulded parts are features that would prevent the part from being directly ejected from an injection moulding device. The injection moulding device preferably comprises—or substantially consists of—a first mould form and a second mould form, and does preferably not comprise an auxiliary device for causing an undercut of the receiving part, e.g. a side pull.

Preferably, the receiving part has multiple rib portions, and preferably at least one of the funnel-shaped inner volume and the ball-receiving inner volume is defined by the surface of the multiple rib portions, which are facing the funnel-shaped inner volume and/or the ball-receiving inner volume. A rib portion may be provided with a predetermined elasticity, e.g. when a rib portion is configured to be a click wall for retaining the ball-shaped end of the male part, in the coupling position. Moreover, the provision of rib portions reduces the material required for forming the receiving part and thereby also reduces the weight of the receiving part, which is of particular importance in the car industry.

Preferably, at least one rib portion, multiple rib portions or all rib portions are aligned at least in part around the ball-receiving inner volume and/or the same rib portions and/or other rib portions aligned at least in part along the funnel-shaped inner volume. This way, a light-weight design of the receiving part is provided.

Preferably, the receiving part comprises a first set of rib portions and, preferably, comprises a second set of rib portions. Preferably, the rib portions of the first set of rib portions and the rib portions of the second set of rib portions are different. The ball-receiving inner surface of the ball-receiving portion, preferably, is defined by the first set of rib portions, which defines at least a part of the first half of the ball-receiving inner volume, and, preferably, ball-shaped inner volume, i.e. spherical inner volume, and by the second set of rib portions, which defines at least a part of the second half of the ball-receiving inner volume, in particular when considering the receiving part be divided by a virtual plane running through the centre of the ball or sphere, respectively.

For the purpose of illustration, the first half of the ball-receiving inner volume or sphere may be considered to be the upper half of the ball-receiving inner volume, and the second half of the sphere may be considered to be the lower half of the ball-receiving inner volume. The terms up and low can be understood when considering that the female part is intended to be fixed at the bottom side of the top cover of an engine in a mounting position, which means that the bottom side of the top cover is facing the ground, i.e. the normal vector of the bottom side is substantially parallel to the positive direction of gravity. Since the male part is usually connected to the engine housing, the ball-shaped end of the male part usually is directed substantially upwards. When the ball-shaped end of the male part enters the receiving part, then it may first pass the funnel-shaped receiving portion, then move through the lower half of the ball-receiving inner volume and, at last, reach the upper half of the ball-receiving inner volume, where it fills the ball-receiving inner volume, preferably by a positive-fit connection in case of a ball-shaped inner volume.

The equator plane, which divides the ball-receiving inner volume into an upper half and a lower half, may also understood to—virtually—divide the receiving part in an upper portion and a lower portion. This may be of importance because the receiving part is formed by moulding, wherein the upper portion may be formed substantially in the upper mould form and the lower portion may be formed substantially in the lower mould form of the moulding device, which may be used in a moulding machine. Using a proper arrangement of the rib portions, it can be avoided that undercuts have to be used for creating the receiving part.

The receiving part also preferably defines an opening and/or a channel, acting as the entry position for the ball-shaped end of the male part, which preferably has a circular cross section and which preferably connects the funnel-shaped inner volume with the spherical inner volume. The virtual axis running through the centre of the spherical inner volume and through the centre of the opening, or through the south pole and the north pole of the spherical inner volume, respectively, is referred to as central axis of the receiving part.

Preferably, the first set of rib portions may be arranged substantially in the upper portion of the receiving part and the second set of rib portions may be arranged substantially in the lower portion of the receiving part. This allows to mould the first set of rib portions in a first mould form and to mould the second set of rib portions in a second mould form, in particular without creating undercut portions at the receiving part. Preferably, the rib portions of the first set and/or the second set of rib portions are arranged substantially in parallel to the lines of longitude of the spherical inner volume, referred to as longitudinal rib portions. Preferably, the longitudinal rib portions are arranged in a distance to each other, preferably are arranged equidistant.

Preferably, the number N of rib portions of the first set of rib portions equals the number N of rib portions of the second set of rib portions, wherein preferably N>=2, preferably 2<=N <=10, more preferably 3<=N<=6 and most preferably N=4, wherein the values 3<=N<=6, and in particular N=4, have experimentally proven to allow for designing a receiving part with desirable mechanical properties, when using a thermoplast.

In a preferred embodiment, the rib portions of the first set of rib portions and the rib portions of the second set of rib portions are arranged with an offset by a rotation to each other around the central axis, wherein the rotational shift preferably corresponds to an angle b=360°/(2*N)=180°/N. The distance between the longitudinal rib portions of the first and second set of rib portions may be such that the vertical projections of all rib portions onto the equator plane do not cross each other. This allows to mould the first set of rib portions in a first mould form and to mould the second set of rib portions in a second mould form, without creating undercut portions at the receiving part. Moreover, an optimum of mechanical stability is achieved, while providing a particular light-weight and cost saving construction. Moulding a part without undercut portions is advantageously, because, in general, undercuts may be moulded, but require a side action or side pull. This part has to be used additionally to the two mould forms for being moved separately from the two halves of mould forms, thereby increasing the cost of the moulded part due to an added cost of the mould itself and added complexity of the injection moulding device used in the injection moulding machine.

Preferably, the rib portions of the first set of rib portions are formed to be lamellae. Preferably, the rib portions of the first set of rib portions extend longitudinally in the direction from the equator of the spherical inner volume towards the north Pole, while they are preferably self-supporting, i.e. are not connected at the north pole. Preferably, a rib portion is integrally connected to a side wall of the receiving part, wherein said side wall may be substantially parallel to the central axis and/or may be substantially cylindrically. Preferably, a rib is provided, to at least in part support said lamella at the side wall. Such self-supporting rib portions are acting like a spring, and may serve to dampen vibrations and thereby dampen noise emitted from the source of noise, which may be the engine of the motor vehicle.

Preferably, the receiving part has at least a first support element, which supports a first half of the ball-shaped end of the male part, and preferably has at least a second support element, which supports a second half of the ball-shaped end of the male part. The at least one first support element and/or the at least one second support element can be, respectively, configured to be elastically bendable. Such a configuration can be advantageously made using the thermoplast.

Preferably, the rib portions of the first set of rib portions, in the coupling position and/or the mounting position, support the ball-shaped end of the male part in the upper half of the sphere, which corresponds to the ball-shaped end, and/or, preferably, the rib portions of the second set of rib portions, in the coupling position and/or the mounting position, support the ball-shaped end of the male part in the lower half of the sphere.

Preferably, the rib portions of the second set of rib portions are formed to be click walls, which have been explained above. Preferably, the rib portions of the second set of rib portions do also define the inner surface of the funnel-shaped receiving portion. This way, a particular light-weight and mechanically stable construction is achieved.

Preferably, the sliding portion of the holding part includes a first sliding surface and a second sliding surface, facing the first sliding surface.

Preferably, the holding part has a first support wall and, preferably, a second support wall, facing the first support wall. The first support wall and, preferably, the second support wall, may be arranged parallel to a—considered virtual—support plane, and may be made from a plane plate, respectively, which may have the shape of a circular disc, respectively.

Preferably, the first support wall and the second support wall are arranged in a distance to each other, thereby defining an insert volume of the holding part, which is adapted to receive the receiving part by inserting the receiving part into the insert volume of the holding part, in particular by a sliding movement along the sliding portion of the holding part. Said distance, preferably, substantially corresponds to the height of the receiving part.

Preferably, the snap-in mounting comprises a clamping device for clamping the receiving part within the holding part. The clamping device, preferably, is adapted to counteract the sliding movement of the receiving part relative to the holding part by friction.

Preferably, the first support wall and the second support wall are arranged substantially parallel to each other and in particular parallel to a virtual support plane. This allows for an even sliding motion of the receiving part relative to the holding part. More preferably, at least a part of the first support wall and/or at least a part of the second support wall are arranged under an angle a with each other or to said support plane, wherein preferably a is selected from preferred ranges of angles 0,1° to 20,0°, 5,0° to 20,0°, 10° to 20°. In experiments, the angle a being approximately 15° turned out to be particularly effective. Preferably, said part of the first support wall and/or said part of the second support wall are defining an opening of the insert portion of the holding part. Said opening, preferably is configured to insert the receiving part into the holding part, which may be particularly facilitated by providing the angle a.

The average distance between the first and second support wall as well as the angle a and the corresponding height of the receiving element can be used in combination to adjust a clamping force, which clamps the receiving part between the first and second support wall, when the receiving part is inserted into the insert volume. Since preferably both, the holding part and the receiving part are formed using a thermoplast, the material elasticity of the holding part and the receiving part also contribute to easily achieving an adequate clamping force in combination with the angle a.

The clamping device, preferably, is realized by providing the first support wall and the second support wall being arranged in distance and substantially arranged tilted by said angle a with respect to each other, and that the receiving part is clamped between the first support wall and the second support wall.

Moreover, it is possible and preferred that the clamping device is realized by providing the first support wall and the second support wall being arranged in a first distance and substantially arranged parallel to each other, and by providing the receiving part with at least one first support portion, which is supported by the first support wall and at least one second support portion, which is supported by the second support wall of the holding part when the receiving part is inserted between the first support wall and the second support wall, the first and second support portions being arranged in a second distance from each other, thereby defining a height of the receiving part, wherein the second distance is larger than the first distance, such that the receiving part is clamped between the first support wall and the second support wall. Thereby, it is also possible that the receiving part defines two opposing support planes, which may be tilted by the angle a against each other.

Since preferably both, the holding part and the receiving part are formed using a thermoplast, the material elasticity of the holding part and the receiving part also contribute to easily achieving an adequate clamping force, with respect to all embodiments of the clamping device. The clamping device, preferably, provides a restriction of the movement of the receiving part relative to the holding part in a direction vertical to the support plane of the holding part. Moreover, the clamping device, preferably, provides a clamping force for holding the receiving part within the holding part such that the receiving part remains movable by sliding. The clamping allows for easily positioning the receiving part relative to the holding part, which facilitates the centring of the receiving portion relative to a ball-shaped male part.

Preferably, the first and second support wall are connected to each other by a carrier construction, which preferably is made of a single wall, which may be cylinder-shaped or cone-shaped, or made by multiple, i.e. at least two, walls, which are arranged in distance to each other. This allows for a further weight reduction of the snap-in mounting. The multiple walls of the carrier construction may also be arranged to contact each other.

Preferably, the carrier construction has an opening, which is adapted to insert the receiving part in the insert space of the holding part through the opening, in particular by a movement in parallel to the support plane of the holding part.

Preferably, the carrier construction has a base portion, which is adapted to be fixed to the bottom side of the top cover, preferably by using a welding process, in particular an ultrasonic (US) welding process, or by using adhesive. Other fixing techniques may be used, which may be based on force-fit connections, e.g. using a thread or clamp, or form-fit connections, e.g. using bayonet fixing. The base portion may comprise a plate, which may be substantially plain and/or may have a circular-ring shape.

Preferably, the carrier construction has at least one leg portion, which is arranged to connect the base portion in a distance from the rest of the holding part. The length of the at least one leg portion may be used to eventually adjust the distance, at which the receiving part is positioned relative to the bottom side of the top cover. The at least one leg portion may be made from a single wall, which may be cylinder-shaped or cone-shaped, or made by multiple, i.e. at least two, walls, which are arranged in distance to each other. This allows for a further weight reduction of the snap-in mounting. The multiple walls of the carrier construction may also be arranged to contact each other.

The carrier construction, in particular the base portion, the at least one leg portion and/or the at least one support wall may have one or more openings or recesses and/or local stiffening elements, which may serve for further reducing the weight of the holding part, while providing a sufficiently stable construction.

Preferably, the holding part has an opening or a recess, which is configured to let a user manually push out the receiving part from the holding part, when the receiving part is inserted into the insert volume.

Preferably, the holding part has a restriction device to restrict the sliding movement of the receiving part relative to the holding part to a predetermined range of a sliding area, in particular by blocking the sliding movement by means of at least one restriction portion. Preferably, the holding part has at least one restriction portion, which restricts the sliding displacement of the receiving part relative to the holding part along a support plane, in particular by defining maximum displacement values, preferably in x and y direction, when considering the support plane to be parallel to a Cartesian coordinate system.

A maximum displacement in x direction is the maximum distance, along which the receiving part can be moved by a movement along the positive x-axis starting from a first stop position, where the receiving part abuts on a first section of the restriction portion and said movement ending in a second stop position, where the receiving part abuts on a second section of the restriction portion. A maximum displacement in y direction is the maximum distance, along which the receiving part can be moved by a movement along the positive y-axis starting from a third stop position, where the receiving part abuts on a third section of the restriction portion and said movement ending in a fourth stop position, where the receiving part abuts on a fourth section of the restriction portion.

Preferably, the displacement is evenly restricted within the support plane to a circular sliding area. Restriction may be achieved by the restriction portion, which may comprise an opening or a recess of the holding part, which preferably is circular and which acts as a forcible control for guiding a—preferably also circular-shaped—engagement projection of the receiving part, which may be an integral part of the receiving part and which engages the opening or recess of the holding part, when the receiving part is inserted into the insert volume of the holding part. The displacement being limited by the restriction device serves to provide a tolerance for centring the receiving part, in particular the ball receiving portion, with respect to the ball-shaped end of the male part, when the top cover is mounted onto the engine of a motor vehicle.

Preferably the maximum displacement values in x and y direction are chosen in dependence on the opening diameter of the funnel of the funnel-shaped portion of the receiving part, e.g. the maximum displacement in x and y direction may, respectively, correspond to said opening diameter of the funnel, the opening diameter being the maximum diameter of the funnel. Preferably, the maximum displacement d is chosen from the preferred range 1.0 mm<=d<=5.0 mm, and preferably 2.0 mm<=d<=4.0 mm, wherein in the preferred case of d=3.0 mm, in the position where the receiving part is inserted into the holding part and centred, the receiving part can be displaced to a maximum of 1.5 mm in each positive or negative x and y direction.

Preferably, the receiving part consists of a first polymer material, and/or the holding part consists of a second polymer material, wherein, preferably the receiving part and/or the holding part is formed as a one-piece part, in particular by moulding. Preferably, the first polymer material and the second polymer material are substantially the same material. Preferably, the receiving part consists of a first polymer material containing at least the thermoplast, and the holding portion part consists of a second polymer material, which contains the same thermoplast. This way, fabrication of the snap-in mounting is cost-efficient.

Preferably, the first polymer material is made from one thermoplast. This allows for a cost saving manufacturing of the receiving part and the snap-in mounting and provides desirable mechanical properties of the receiving part. The first polymer material may also be a blend of thermoplasts.

It is also possible that the first polymer material contains a filler material, e.g. a glass fiber and/or a mineral fiber. Thereby, the mechanical abrasion of the already stable thermoplast may be further enhanced.

The term “thermoplast”, presently, does not include elastomers, which in particular also are commercially available with thermoplastic properties within a limited temperature range. The thermoplasts provided for the present invention do have a lower density and/or lower purchase price than a conventional elastomer; therefore a cost saving light-weight construction can be achieved. This means, that the first polymer material, and preferably also the second polymer material, is a non-elastomer and is substantially non-elastomeric, in particular compared to an elastomer like natural rubber. With other words: thermoplasts excluding thermoplastic elastomers.

Preferably, polymer material, in particular the first polymer material and preferably also by the second polymer material, are chosen such that the elastic modulus Eₜ , i.e. the modulus of elasticity in tension, measured preferably by ASTM D638-10 or more preferably ISO 527-1:2012, respectively, of the first polymer material and preferably also by the second polymer material, is chosen from the preferred ranges having a lower limit Eₜ_{_}ₘᵢₙ and an upper limit Eₜ_{_}_{max,} wherein Eₜ_{_}ₘᵢₙ is preferably chosen from the group of values 0.11; 0.15; 1.00; 1.40; 2.00 and wherein Eₜ_{_}ₘₐₓ is preferably chosen from the group of values 5.00; 10.00; 20.00; 50.00, each value being expressed in Gigapascal (GPa), and preferably 0.11 GPa<Eₜ<50 GPa, or 0.15 GPa<Eₜ<20.00 GPa or 0.15 GPa<Eₜ<5.00 GPa. The elastic modulus Eₜ typically is higher in case that the polymeric material contains a filler, e.g. reinforcement fibres. Elastomers, for example, typically have 0.001 GPa<Eₜ<0.10 GPa.

Preferably, the elastic modulus Eₜ₁ of the first polymer material and the elastic modulus Eₜ₂ of the second polymer material are substantially equal, which means, in particular, that the Eₜ₁ and Eₜ₂ due not differ by more than a maximum of dEₜ , wherein in particular, the absolute value of the difference between Eₜ₁ and Eₜ₂ is smaller than dEₜ , which may be expressed as dEₜ<=|Eₜ₁-Eₜ₂|. Hereby dEₜ is chosen form the group of values including 0.50, 0.20, 0.10, 0.05, 0.01, expressed in GPa. Providing substantially the same values for Eₜ₁ and Eₜ₂ allows to choose similar or identical materials for the first polymer material and the second polymer material, which each may contain a similar or the same thermoplast. This way, production costs of the snap-in mounting may be relatively low.

Surprisingly the loss of acoustic dampening, which occurs due to the omission of a conventional elastomeric decoupler arranged between the top cover and the engine of the motor vehicle as a part of a conventional mounting, can be compensated by providing an acoustically self-dampening construction of the top cover. A top cover, which at least contains a fibrous structural layer, was found to provide a satisfying acoustically dampening when used in combination with the snap-in mounting according to the invention. Therefore, acoustical dampening can be also easily achieved by using the simplified and cost-saving construction of the snap-in mounting according to the invention.

Preferably, the base part of the holding part is supported by the fibrous structural layer of the top cover. Preferably, the base part of the holding part is connected to and or anchored in the fibrous structural layer of the top cover such that sound-caused vibrations of the base part are transferred to the fibrous layer. Preferably, the base part is welded to the fibrous structural layer, which offers a particular costly and reliable connection while preserving the self-dampening property.

A fibrous layer, or multiple fibrous layers, forms a structural layer of the cover. Structural layer is meant in particular, that the major fraction of the stiffness of the cover is contributed by the one fibrous layer or multiple fibrous layers, in particular. Acting as a carrier layer, the one or more fibrous layer of the cover has a larger stiffness than the residual layers of the layer setup of the cover, when measuring the stiffness. When the at least one fibrous layer is used as the structural layer, i.e. carrier structure, of the cover, no further carrier structure is required. Then, the at least one fibrous layer is preferably the only carrier structure of the cover. In particular, the cover preferably has the at least one structural layer being used as the carrier layer(s) and does not have a superposed layer or structure of a solid material, which acts as a carrier structure, e.g. a solid plastic material. Solid thick plastic layers, which have been used in the prior art, are not required. In consequence, such a cover is lightweight and stable. Moreover, any acoustic vibrations associated to solid material layers acting as a carrier layer are avoided.

The at least one structural layer comprises at least of fibers and a thermoplastic binder or a thermoset binder, whereby the binder forms small binding points between the fibers.

The fibers are at least one of thermoplastic fibers, for instance polyester fibers, like polyethylene-terephthalate, natural fibers, like flax or cotton or mineral fibers, like glass fibers, ceramic fibers, carbon or basalt fibers or a combination of those fibers. It can also be a mixture of such fibers, for instance a mixture of polyester and glass fibers. The fibers can be staple fibers or endless filaments.

As a thermoplastic binder either a copolymer of polyester, or polyamide, preferably polyamide 6 or polyamide 66 can be used. Preferably the binder is in the form of fibres, flakes or powder, whereby fibers are best to obtain a more homogenous mixture with the other fibers.

Alternative a thermoset binder can be used for instance a resinous type of material like phenolic resin.

The area weight of the structural layer is preferably between 200 and 1700 g/m², preferably between 400 and 1500 g/m².

The structural layer fulfils latest flammability requirements for the engine bay. The use of a fibrous structural layer as a carrier, in particular, also offers thermal insulation. In case of the cover being an engine top cover, the thermal insulation helps to keep the engine at an efficient operating temperature.

All polymers used can be virgin or coming from recycled resources, including reclaimed, regenerated or other types of recycling, as long as the material requirements are given.

An examples of possible fibre compositions is (% given are % by weight):
Glass fibers mixed with polyamide binder fibers whereby the binder fibers will melt and form bonding points between the glass fibers. Preferably a mixture of between 55 and 80% of glass fibers and between 45 and 20% of Polyamide binder fibers are used. The glass fibers might be replaced at least in part by other filler fibers like polyester fibers, for instance PET or PBT. This has the further advantage that the trim part can use mounting means without a decoupling element also on vibrating surfaces without increasing vibrational noise.

Other examples of possible fibre compositions are (% given are % by weight):
Glass fibers mixed with a thermoset binder, like for instance a glass fiber mat (also called glass wool) with 10-20%, preferably 15% phenolic resin. The glass fibers might be replaced at least in part by filler fibers like cotton and/or polyester, for instance 15-20% phenolic resin, 25-30% cotton and/ or PET fibers, and 50-60% glass fibers.

Alternatively a fibrous solution without glass fibers might be chosen, for instance a mixture of PET and polyamide fibers whereby the polyamide fibers will melt and form bonding points between the PET fibers. Preferably the part is moulded under direct contact with water saturated steam under pressure whereby the apparent melting point of the polyamide is decreased under its melting temperature as measured with differential scanning calorimetry (DSC). So the melting temperature of the PET can be at least 240° C. By using this method the polyester fibers will not melt and stay a fibrous network in the carrier material, keeping the noise absorbing character of a fibrous layer.

Preferably, the base part of the holding part is supported by the structural layer of the top cover. Preferably, the base part of the holding part is connected to, in particular anchored in, the structural fibrous layer of the top cover such that sound-caused vibrations of the base part are transferred to the fibrous layer. Preferably, the base part is welded to the fibrous layer, which offers a particular costly and reliable connection while preserving the self-dampening property. Preferably the base part is materially connected directly to the material of the structural layer, without an intermediate layer. Preferably intermediate layer are punctured during the welding process to enable the material connection.

With materially connection is meant that the material of the carrier layer and the material of the connecting area of the mounting are bonded such that they cannot be taken apart without damaging at least one of the materials. Although an adhesive might be used, there should be at least an intimate contact between the two main materials directly.

Surprisingly by using the preferred structural layer together with the stiff mounting solution as disclosed, ergo without an elastomeric decoupling element, the vibrational noise is not increased and even more surprisingly the durability of the part is better. By using the combination of the material and the mounting solution without the decoupling element it is possible to decrease the overall weight and still to keep all features necessary for the performance. Against the dogma in the industry, that a decoupler is needed at all times, it was found that for the material combination with the snap in mounting solution as disclosed and claimed this is not necessary.

In another preferred embodiment of the snap-in mounting according to the invention, which is exemplarily explained hereinafter with reference to FIGS. 8a and 8b, the holding part has a support wall and a base portion, which is connected, preferably integrally connected, with the support wall by at least one connection element, which can be at least one side wall.

The holding part of the snap-in mounting, preferably, has an opening and defines an insert volume for inserting and receiving at least a part of the receiving part, and the receiving part has an insert portion, which may be formed as a circular-ring disc element or a circular disc element, which is dimensioned to fit into the insert volume and to remain movable within the insert volume by a sliding movement, wherein the receiving part has a receiving portion, which is integrally connected to the insert portion and which at least partly protrudes through the opening.

The support wall, the at least one connection element and the base portion are preferably arranged such that they—in combination with the bottom side of the top cover—define the insert volume of the holding part, because the holding part and in particular the support wall are preferably configured such that the support wall is held in a distance to the bottom side of the top cover in the mounting position.

The insert volume is preferably adapted to receive at least in part or fully the receiving part by inserting the receiving part at least partly into the insert volume of the holding part, in particular before fixing the snap-in mounting to the bottom side of the top cover. Said distance, preferably, substantially corresponds to the height of the receiving part. Also for this embodiment, a restriction device for restricting the movement and/or a clamping device for counteracting said movement in any direction in the plane parallel to the support wall may be provided.

The receiving part has an insert portion, which may be formed as a cylindrical element or a circular-ring disc element or a circular disc element, which is dimensioned to fit into the insert volume and to remain movable within the insert volume by a sliding movement. The receiving portion, which is configured for receiving the ball-shaped end of the male part, may protrude from the opening provided in the support wall. The base part can be a circular-ring shaped disc element, and the support wall preferably also is a circular-ring shaped disc element. The support wall has an opening, which acts as a pass-through for letting the receiving part protrude from the insert volume. Such an embodiment also provides the feature of self-centring, which is advantageously for compensating positioning errors occurring during production and fixing of the snap-in mounting to the bottom side of the top cover. Said alternative embodiment is particularly low-cost in the production and light-weight.

The invention also is directed to a top cover for covering the engine of a motor vehicle, having a top side and a bottom side, wherein at least one snap-in mounting according to the invention is connected with the bottom side of the top cover, for mounting the top cover onto the engine of a motor vehicle.

Preferably, the top cover is provided with at least one snap-in mounting according to the invention, which is fixed, in particular by welding, e.g. by ultra-sonic welding, or adhesion or another fixation technique, to the bottom side of the top cover. Preferably, a plurality of, i.e. a minimum of two, snap-in mountings according to the invention are fixed at different positions to the bottom side of the top cover. This allows the top cover to be mounted in a stable position on the engine of a motor vehicle.

Preferably, at least one snap-in mounting or a plurality of snap-in mountings according to the invention is/are fixed at different positions to the bottom side of the top cover, wherein exactly one snap-in mounting is provided, which does not have the self-centring feature, which means that the receiving part cannot be slidably moved at the holding part of the snap-in mounting by the ball-shaped end of the male part during coupling of the female part and the male part. Such a snap-in mounting, which does not have the self-centring feature, is also considered to be an invention and is defined as follows:

Snap-in mounting for mounting a top cover onto the engine of a motor vehicle, comprising a female part including (consisting of) a receiving part, which is adapted to receive the ball-shaped end of a male part by a snap-in connection, and a holding part for holding the receiving part, wherein the receiving part and the holding part are integrally moulded parts, wherein the holding part is adapted to be fixed to the top cover's bottom side, which faces the engine of a motor vehicle when mounted, characterized in that the receiving part is moulded from a polymer material containing at least a thermoplast.

The snap-in mounting, which does not have the self-centring feature, serves as the first mounting point, where the top cover is first mounted to the male part at the engine, where it remains rotatable around the central axis of the mounting point, wherein the at least one snap-in mountings according to claim 1, having the self-centring feature, will be mounted subsequently to the residual male parts at the engine, wherein possible positioning errors of the female parts of the snap-in connection according to the invention or possible positioning errors of the male parts, the errors being within the considered tolerances, will be compensated by the self-centring feature.

Preferably, the top cover, having at least one snap-in mounting according to the invention being connected with the bottom side of the top cover, is acoustically self-dampened. The configuration of the top cover to have sound dampening properties can be achieved by several preferred embodiments of the invention.

Preferably, the receiving part will contribute to sound dampening, if it contains at least one or multiple rib portions, which are formed by walls of the polymer material containing a thermoplast. Such walls, may be configured to bend due to the actuation of vibrations caused by sound, thereby dampening the sound associated with said vibrations. For example, the rib portions may be formed self-supporting or as lamellae, thereby acting as a spring.

Preferably, the capability of the receiving part to perform a sliding movement at the holding part, may be used to a provide a capability of the snap-in mounting according to the invention to dampen such vibrations, which occur along the support plane of the holding part, thereby dampening the sound associated with said vibrations.

Moreover, the invention is directed to a mounting system comprising at least one snap-in mounting according to the invention, which in particular already contains the female part according to claim 1, and to at least one male part having a ball-shaped end, which may be coupled to said female part by a snap-in connection. The coupling end of the male part is not mandatory ball-shaped, but may have a different shape, as long as it can be coupled to the female part. The male part may comprise an stud, which preferably is linear elongated, the ball-shaped end being connected to an end of the stud, while the other end of the stud is configured to be mounted to the engine or engine housing or engine carrier frame of a motor vehicle, e.g. by comprising a fixing device, e.g. a thread, anchor, bayonet or base part, at the end of the stud.

The invention is also directed to a method of producing the snap-in mounting according to the invention, which means according to claim 1 or any preferred embodiments of the as described with the invention, the method providing at least the steps of: forming the receiving part by injection moulding, and providing the holding part, preferably assembling the receiving part and the holding part by inserting the receiving part into the holding part, wherein the latter step preferably is reversible such that the receiving part may be removed from the holding part. In particular, the receiving part is formed by injection moulding using an injection moulding device having a first mould form and a second mould form, wherein the first and second mould forms are configured such that the receiving part does not have an undercut portion. This way, the receiving part can be directly ejected from the injection moulding device after finishing the moulding. Hereby, the first mould form may be configured to define the negative contour of a first set of rib portions of the receiving part, and the second mould form may be configured to define the negative contour of a second set of rib portions of the receiving part, which was already described above. The method according to the invention allows for producing a light-weight snap-in mounting having desirable mechanical properties, while the production method is cost-saving.

The invention is also directed to a moulding device for moulding at least the receiving part of the snap-in mounting according to the invention. The moulding device preferably is configured to be an injection moulding device, i.e. is configured for injection moulding at least the receiving part of the snap-in mounting according to the invention. This allows for a cost-efficient fabrication of the snap-in mounting. The moulding device is preferably configured for use in a moulding machine, in particular an injection moulding machine. The moulding machine preferably is configured to process a moulding material containing—or consisting of—the at least the thermoplast. Preferably, the moulding device comprises a first mould form and a second mould form, which can be closed to define the negative contour of the receiving part. Preferably, the receiving part, the first mould form and a second mould form are respectively configured such that the receiving part does not require an undercut portion.

Further embodiments of the method according to the invention or the moulding device according to the invention may be derived from the description of the snap-in mounting according to the invention, and vice versa. Further embodiments of the snap-in mounting according to the invention and the method according to the invention can be also derived from the description of the embodiments shown in the figures and the figures.

### FIGURES AND FURTHER EMBODIMENTS

FIG. 1 shows a perspective view of a snap-in mounting according to the invention in a first embodiment, wherein a major part of the snap-in mounting was cut out for illustrating the inner setup of the receiving part, wherein a part of the top cover is also shown, with the bottom side of the top cover facing upwards, which is the opposite direction of the normal mounting position, where the bottom side faces downwards.

FIG. 2a shows the complete snap-in mounting of FIG. 1, in a perspective view similar to FIG. 1.

FIG. 2b shows the complete snap-in mounting of FIG. 1, in another perspective view similar to FIG. 2a.

FIG. 2c schematically explains a detail of the snap-in mounting of FIG. 1, in a cross-sectional side view.

FIG. 3 shows a perspective view of an embodiment of a top cover according to the invention in a first embodiment, which is provided with four snap-in mountings of FIG. 1, wherein the bottom side of the top cover is shown facing upwards.

FIG. 4 shows a side view of the receiving part of the snap-in mounting of FIG. 1, wherein a half of the receiving part is cut out for illustrating the inner setup of the receiving part.

FIG. 5 shows a perspective view of the full receiving part of FIG. 4.

FIG. 6 shows a perspective view of the snap-in mounting of FIG. 1, in a position, which is more typical for a normal mounting position, wherein the snap-in mounting is turned upside down in comparison with FIG. 2.

FIG. 7a shows a perspective view of an embodiment of a top cover according to the invention in a second embodiment, which is provided with three snap-in mountings of FIG. 1 and one snap-in mounting, which is not self-centring, wherein the bottom side of the top cover is shown facing upwards.

FIG. 7b shows the complete snap-in mounting of FIG. 1, in a perspective view similar to FIG. 2b, which is used with the top cover of FIG. 7a.

FIG. 7c shows, in a perspective view similar to FIG. 7b, a further snap-in mounting according to the invention, which is not self-centering, because the holding part and the receiving part are formed integrally.

FIG. 8a shows a perspective view of a mounting system having a snap-in mounting according to the invention in a second embodiment, ni particular shows the male part having a ball-shaped end, which is coupled to the receiving part.

FIG. 8b shows the snap-in mounting of FIG. 8a in a similar perspective, wherein a major part of the snap-in mounting was cut out for illustrating the inner setup of the holding part and the receiving part.

FIG. 8c shows the receiving part of the snap-in mounting of FIG. 8a in a similar perspective.

FIG. 8d shows the holding part of the snap-in mounting of FIG. 8a in a similar perspective.

FIG. 8e shows the assembled snap-in mounting of the mounting system in FIG. 8a in a similar perspective.

FIG. 9a shows, in a perspective view similar to FIG. 8a, a further mounting system having another snap-in mounting according to the invention, which is not self-centring, because the holding part and the receiving part are formed integrally.

FIG. 9b shows, in a perspective view similar to FIG. 1, the snap-in mounting of FIG. 9a.

FIG. 10 shows a diagram with the method steps of an embodiment of the method according to the invention for producing a snap-in mounting according to the invention.

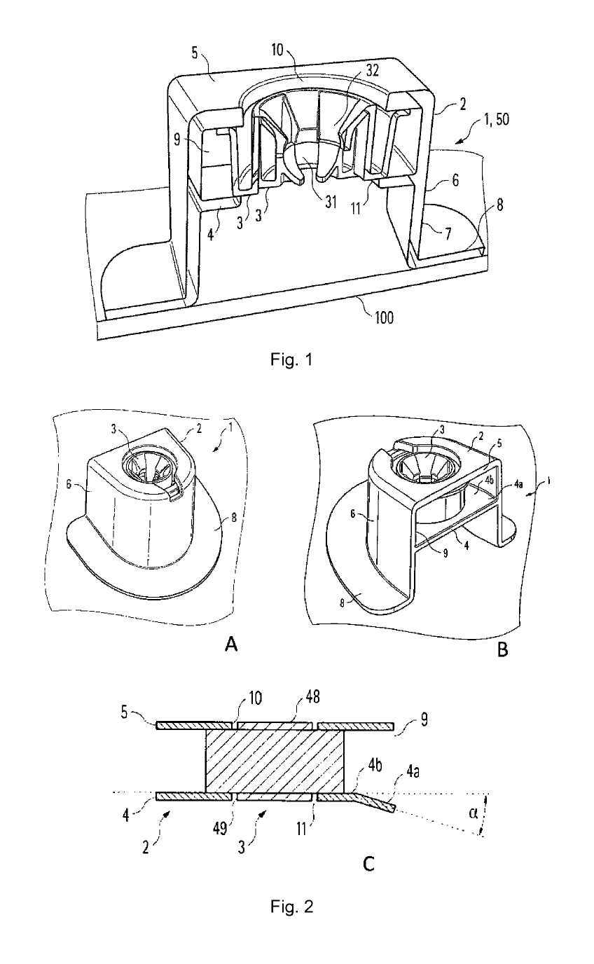

FIG. 1 shows the snap-in mounting 1 according to the invention in a first embodiment, wherein a major part of the snap-in mounting was cut out for illustrating the inner setup of the receiving part 3, wherein a part of the top cover 100 is also shown, with the bottom side of the top cover 100 facing upwards, which is the opposite direction of the normal mounting position, where the bottom side faces downwards.

The snap-in mounting 1 serves for mounting the top cover 100 onto the engine of a motor vehicle. The snap-in mounting 1 consists of the female part 50. The female part 50 consists of the holding part 2 and the receiving part 3. The holding part 2 is adapted to be fixed to the top cover's 100 bottom side, which faces the engine of a motor vehicle when mounted, and the holding part also serves for holding the receiving part 3. The receiving part 3 is adapted to receive the ball-shaped end of a male part 60 by a snap-in connection. The receiving part is formed by a thermoplast, here e.g. polyamide, using injection moulding.

The holding part 2 has a first support wall 4 and a second support wall 5, facing the first support wall 4. Both support walls are plain plates, which are arranged in a distance, thereby limiting the insert volume of the holding device 2 for inserting the receiving device 3 through an opening 9, best seen in FIG. 6, of the holding device by a lateral movement, which is parallel to the second support wall 5. Said distance substantially corresponds to the height of the receiving part 3.

The first support wall 4 and a second support wall 5 are plain plates, carried by a carrier construction, to which the support walls 4, 5 are integrally connected. The second support wall has an opening, which technically is used as a part of the restriction device, explained below, and which also serves for allowing to let the ball-shaped end of the male part passing through the housing and to engage the ball-receiving portion of the receiving part for establishing the coupling position by snap-in, and for the male part to be removed for releasing the coupling position of the female part and the male part.

As shown in FIGS. 2b and 2c, the first support wall 4 has a first portion 4a and a second portion 4b. The second portion 4b of the first support wall 4 is parallel to the second support wall 5, thereby defining a virtual support plane P, along which the receiving part and the holding part can be slidably moved in relation to each other. Also the base part 8 is parallel to the second support wall 5. The first portion 4a of the first support wall 4 is tilted by the angle a=15° with respect to the second portion 4b of the first support wall 4. Thereby, the opening 9 of the insert volume of the holding part is enlarged and a sliding ramp is defined by first portion 4a, which facilitates inserting the receiving part into the insert volume of the holding part 2. The carrier construction consists of a vertical side wall 6, a leg portion 7 and a base portion 8. The side wall 6 runs substantially parallel to the central axis A of the snap-in mounting, shown in FIG. 1, and provides housing for the receiving device 3 in combination with the second support wall 5. In the position where the receiving part 3 is properly inserted into the insert volume of the snap-in mounting, and the latter is mounted to the bottom side of the top cover of the engine of a motor vehicle, referred to as the mounting position, the housing is encompassing the receiving device 3 and is open only in one lateral direction for providing the insert opening 9, thereby providing a high mechanical stability.

The holding part 3 has a sliding portion, which is adapted to allow for a relative displacement of the receiving part 3 and the holding part 2 by a sliding motion. The sliding portion comprises the first support wall 4 and the second support wall 5, which define the insert volume, into which the receiving part 3 is inserted, while still being capable to be laterally moved, at least under the relatively high forces of positioning, when the male part enters the funnel-shaped receiving portion of the receiving part 3, which thereby is caused to slide and to align, i.e. self-center, the male part with the ball-receiving portion.

The snap-in mounting comprises a clamping device for clamping the receiving part within the holding part. The clamping device, preferably, is adapted to counteract the sliding movement of the receiving part relative to the holding part by friction, such that the receiving part may be still be laterally moved by sliding but may be fixed by friction during the normal mounting position, when the top cover is mounted on top of the engine of the motor vehicle and normally operated. The clamping device is realized here by the plain first support wall 4, which is arranged tilted with respect to the plain second support wall 5 by an angle a, here being 15°. The height of the receiving part, the average distance between the first support wall 4 and the second support wall 5 and the angle a are configured such that a proper clamping effect is achieved. This configuration is facilitated by choosing a thermoplast, here polyamide, for the polymer material of the receiving part, and also for the holding part, which are each formed one-piece by injection moulding.

The holding part 2 has a restriction device to restrict the sliding movement of the receiving part 3 relative to the holding part 2 to a predetermined range of a sliding area, in particular by blocking the sliding movement by means of at least one restriction portion 10. The restriction portion 10, see FIG. 1, is an opening having a circular cross section and being provided in the second support wall 5. The restriction portion 10 restricts the sliding displacement of the receiving part 3 relative to the holding part 2 along a support plane parallel to the second support wall 5. Furthermore, the restriction portion 10 acts as a forcible control for guiding the also circular-shaped engagement projection 48, see FIG. 2c, of the receiving part 3, which is an integral part of the receiving part 3 and which engages the opening 10 of the holding part 2, when the receiving part 3 is inserted into the insert volume of the holding part 2. The displacement being limited by the restriction device serves to provide a tolerance for centring the receiving part 3, in particular the ball receiving portion, with respect to the ball-shaped end of the male part 60, when the top cover 100 is mounted onto the engine of a motor vehicle. In a similar function, the restriction device also comprises the second opening 11 being provided in the first support wall 4, which is engaged by the circular-shaped engagement projection 49 of the receiving part 3. The maximum displacement of the receiving part 3 by a sliding movement within the holding part 2, which is allowed by the receiving part 3, can be dimensioned to be 3 mm, e.g. 1.5 mm laterally in each positive or negative x and y direction of a Cartesian coordinate system, in the position where the receiving part is inserted into the holding part and centred.

The female part 50 forms a mounting system according to the invention, if in combination with a male part having a ball-shaped end, which is adapted to fit into the substantially ball-shaped inner volume of the ball-receiving portion of the receiving part 3.

Referring to FIG. 1, the receiving part 3 has one ball-receiving portion 31 and one funnel-shaped portion 32.

Referring to FIG. 4, the receiving part 3 has four click walls 33, which are arranged and shaped thin enough to be displaced by being elastically bended under the force provided by inserting the ball-shaped end of the male part 60 into the ball-receiving portion 31, such that the click walls support and retain the male part at the receiving part by engaging the undercut provided at the ball-shaped end of the male part, whereby the click walls 33 are also adapted for allowing a smooth release of the ball-shaped end of the male part from the ball-receiving portion, when the female part and the male part are decoupled.

The funnel-shaped receiving portion 32 includes a funnel-shaped inner volume, and the ball receiving portion 31 includes a ball-receiving inner volume, which is substantially ball-shaped.

The receiving part 3 has eight rib portions and the ball-receiving inner volume is defined by the surface of the eight rib portions 34, 35, which are facing the ball-receiving inner volume.

The funnel-shaped inner volume is defined by the surface of the click walls 33, which are at one end integrally connected to a substantially vertical and cylindrical side wall 36 of the receiving part, and at the other end continuously leading into the four rib portions 34, which form the lower part of the ball-shaped receiving portion and the ball-shaped inner volume, respectively.

The ball-receiving portion has an opening 37, through which the ball-shaped end of the male part 60 is inserted into the ball-receiving portion for providing coupling of the female part 50 and the male part 60. The rib portions 34, 35 are aligned at least in part around the ball-shaped inner volume in a longitudinal direction, considering the ball-shaped inner volume having a south pole, which lies in the center of the opening, and an opposing north pole, which are connected by a central linear axis running through both poles and by lines of longitude leading around the ball-shaped inner volume.

The ball-receiving inner surface of the ball-receiving portion 31 is defined by a first set of four rib portions 35, which defines a first half of the ball-shaped inner volume, and by a second set of four rib portions 34, which defines a major part of the second half—also referred to as lower half—of the ball-shaped inner volume, considering the receiving part being divided by a virtual plane P, see dashed line P in FIG. 4, running through the centre of the ball-shaped inner volume.

The rib portions 35 of the first set of rib portions and the rib portions 34 of the second set of rib portions are respectively provided with a number N=4, and are arranged with an offset by a rotation to each other around the central axis, wherein the rotational shift preferably corresponds to an angle b=180°/N=45°. The distance between the longitudinal rib portions 35, 34 of the first and second set of rib portions is chosen such that the vertical projections of all rib portions onto plane P do not cross each other. This allows to mould the first set of rib portions in a first mould form and to mould the second set of rib portions in a second mould form, without creating undercut portions at the receiving part. Moreover, an optimum of mechanical stability is achieved, while providing a particular light-weight and cost saving construction. Moulding a part without undercut portions is advantageously, because, in general, undercuts may be moulded, but require a side action or side pull. This part has to be used additionally to the two mould forms for being moved separately from the two halves of mould forms, thereby increasing the cost of the moulded part due to an added cost of the mould itself and added complexity of the injection moulding machine.

The rib portions 35 of the first set of rib portions are formed to be lamellae which extend longitudinally in the direction from the equator of the spherical inner volume towards the north pole, while they are arranged self-supporting. This way, the rip portions 35 behave flexible like a spring, which contributes to dampen noise, which is associated with vibrations, which are transferred to bend the lamellae 35. Each lamella 35 is supported by a rib element at another substantially vertical side wall 39 of the receiving part 3.

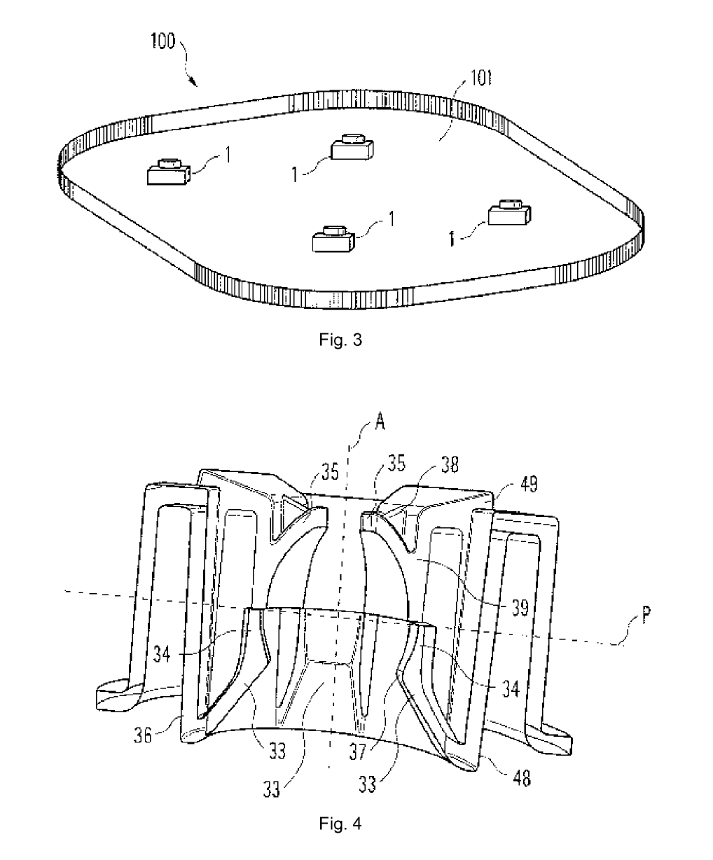

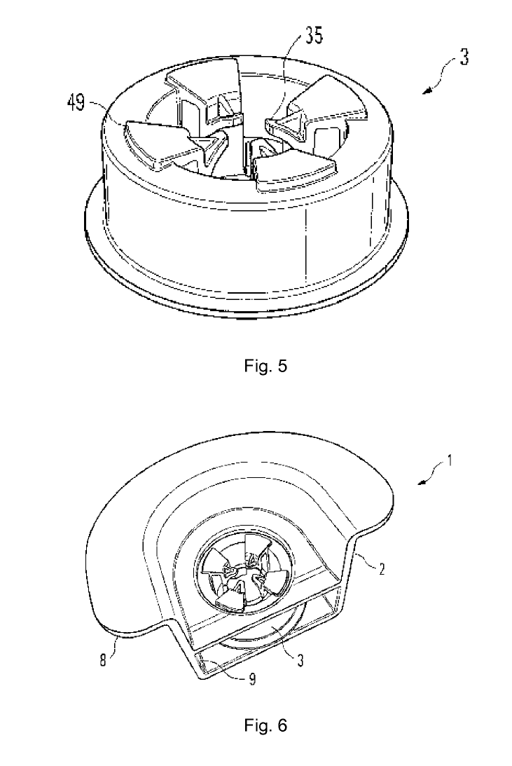

FIG. 3 shows a perspective view of an embodiment of a top cover 100 according to the invention in a first embodiment, which is provided with four snap-in mountings of FIG. 1, wherein the bottom side of the top cover is shown facing upwards. The top cover 100 according to the invention for covering the engine of a motor vehicle has a top side and a bottom side, wherein multiple snap-in mountings 1 according to the invention are connected with the bottom side 101 of the top cover 100, for mounting the top cover onto the engine of a motor vehicle, see FIG. 3. The FIG. 3 indicates that the height of the leg portion 7 of the holding part 2 may be used to compensate for local differences in the distance between the male parts, provided at the engine, and the corresponding mounting side at the bottom side of the top cover 100, in the mounting position of the top cover.

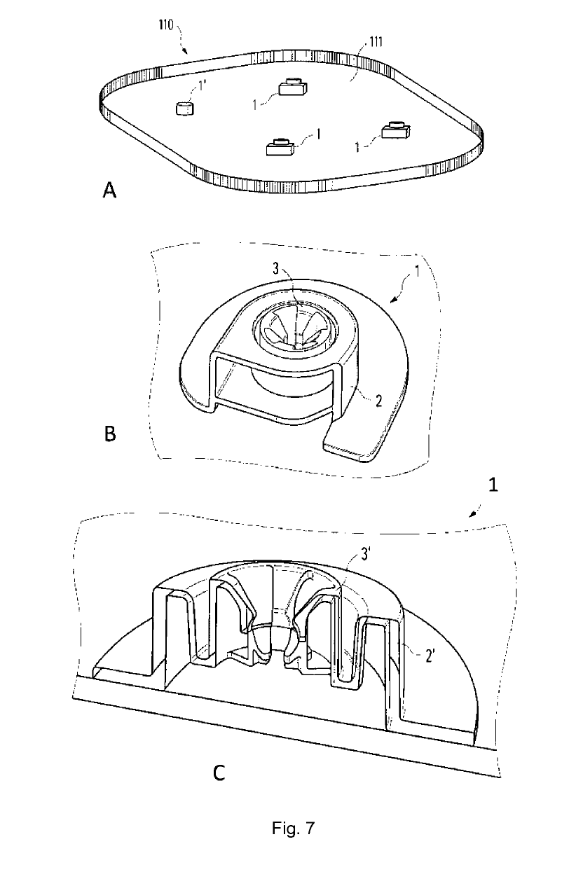

FIG. 7a shows a perspective view of an embodiment of a top cover 110 according to the invention in a second embodiment, which is provided with three snap-in mountings of FIG. 1 and one snap-in mounting 1′, which is not self-centring, wherein the bottom side of the top cover is shown facing upwards. The snap-in mounting 1′, which is not self-centring, has a holding part and a receiving part, which are integrally formed with each other, and which are therefore not including a sliding portion, a clamping device and a restriction device.

The top cover 110 is provided with at least one snap-in mounting 1 according to the invention, which is fixed by US welding to the bottom side of the top cover. Three snap-in mountings 1 according to the invention are fixed at different positions to the bottom side 111 of the top cover 110. This allows the top cover to be mounted in a stable position on the engine of a motor vehicle.

Three snap-in mountings 1 are fixed at different positions to the bottom side 111 of the top cover, wherein exactly one snap-in mounting 1′ is provided, which does not have the self-centring feature, which means that the receiving part cannot be slidably moved at the holding part of the snap-in mounting by the ball-shaped end of the male part during coupling of the female part and the male part. The snap-in mounting 1′, which does not have the self-centring feature, serves as the first mounting point, where the top cover 110 is first mounted to the male part 60 at the engine, where it remains rotatable around the central axis A of the mounting point, wherein the three snap-in mountings 1 according to claim 1, having the self-centring feature, will be mounted subsequently to the residual male parts 60 at the engine, wherein possible positioning errors of the female parts of the snap-in connection according to the invention or possible positioning errors of the male parts, the errors being within the considered tolerances, will be compensated by the self-centring feature.

FIG. 7c shows, in a perspective view similar to FIG. 7b, a further snap-in mounting 1′ according to the invention, which is not self-centring, because the holding part 2′ and the receiving part 3′ are formed integrally. The receiving portion of the receiving part 3′ is formed in analogy to the receiving portion of receiving part 3. The receiving portion of receiving part 3′ is integrally connected to the holding part 2′ via one connecting wall.

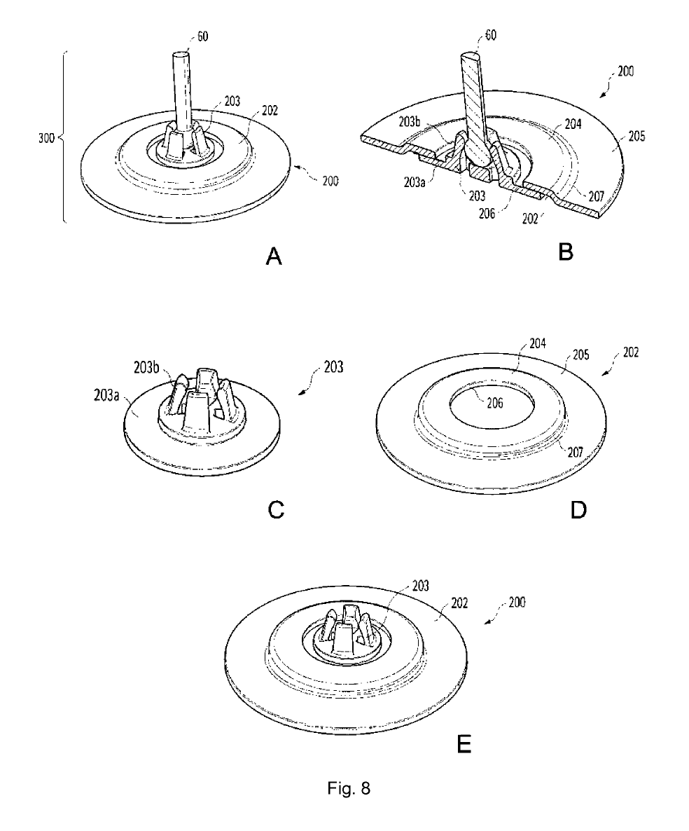

FIG. 8a shows a perspective view of a mounting system 300 having a snap-in mounting 200 according to the invention in a second embodiment, and also shows a male part 60 having a ball-shaped end, which is coupled to the receiving part 203.

Generally, for an embodiment as shown in FIGS. 8a and 8b, the holding part 202 of the snap-in mounting (200) has an opening (206) and defines an insert volume for inserting and receiving at least a part of the receiving part (203), and the receiving part has an insert portion (203a), which may be formed as a circular-ring disc element (203a) or a circular disc element, which is dimensioned to fit into the insert volume and to remain movable within the insert volume by a sliding movement, wherein the receiving part has a receiving portion (203b), which is integrally connected to the insert portion and which at least partly protrudes through the opening (206).

In FIG. 8a, the holding part 202 has a support wall 204, see FIG. 8b, and a base portion 205, which is integrally connected with the support wall 204 by at least one connection element 207, which is a narrow side wall. The support wall 204, the connection element 207 and the base portion 206 are arranged such that they—in combination with a bottom side 101, 111 of the top cover—define the insert volume of the holding part 2, because the holding part and in particular the support wall are configured such that the support wall is held in a distance to the bottom side of the top cover in the mounting position. The insert volume is adapted to receive at least in part the receiving part 203 by inserting the receiving part 203 at least partly into the insert volume of the holding part 202, in particular before fixing the snap-in mounting to the bottom side of the top cover. Also for this embodiment, a restriction device, here comprising opening 206, for restricting the movement and/or a clamping device for counteracting said movement in any direction in the plane parallel to the support wall is provided. The receiving part 203 has an insert portion 203a, which is formed as a circular-ring disc element, which is dimensioned to fit into the insert volume and to remain movable within the insert volume by a sliding movement. The receiving portion 203b, which is configured for receiving the ball-shaped end of the male part, may protrude from the opening 206 provided in the support wall 204. The base part 205 is a circular-ring shaped disc element, and the support wall 204 also is a circular-ring shaped disc element. The support wall has the opening 206, which also acts as a through-hole for letting the receiving part protrude from the insert volume. Such an embodiment also provides the feature of self-centring, which is advantageously for compensating positioning errors occurring during production and fixing of the snap-in mounting to the bottom side of the top cover. Said alternative embodiment is particularly low-cost in the production and light-weight. The receiving portion 203b includes a number N of rib portions, here a number N=4 of self-supporting click walls 233, which allow reliably coupling and uncoupling the female part 250 and the male part 60.

The combination of the snap-in mounting (here: 200) according to the invention and the male part 60 is a mounting system according to the invention.

The top covers 100 and 110 according to the invention both are configured to have self-dampening properties, such that sound absorption is achieved in combination with the snap-in mountings according to the invention, which are formed from a polymer material containing a thermoplast.

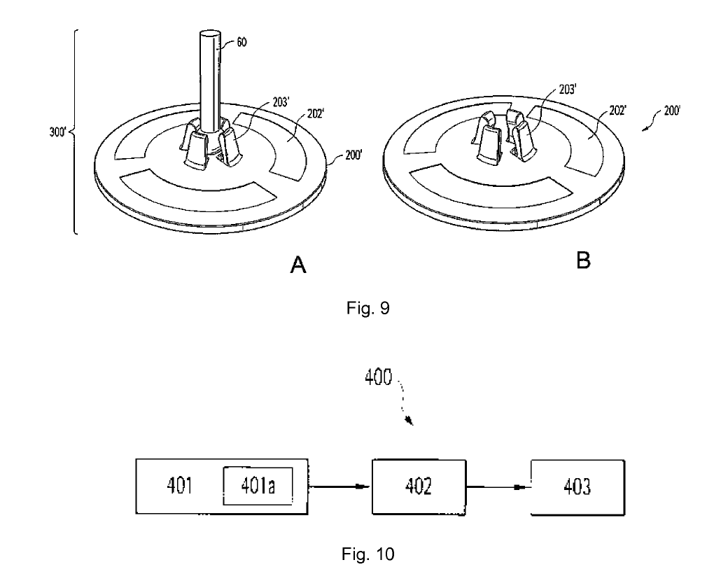

FIGS. 9a and 9b shows, in a perspective view similar to FIGS. 8a and 8e, a further mounting system 300′ having another snap-in mounting 200′ according to the invention, which is not self-centring, because the holding part 202′ and the receiving part 203′ are formed integrally. The receiving portion of the receiving part 203′ is formed in analogy to the receiving portion of receiving part 203.

FIG. 10 shows a diagram with the method steps of an embodiment of the method according to the invention for producing a snap-in mounting according to the invention. The method 400 of producing the snap-in mounting according to claim 1, provides at least the steps of:
forming the receiving part as an integral mould part by injection moulding (401), and
providing the holding part (402), in particular by injection moulding the holding part as an integral mould part;
preferably: assembling the receiving part and the holding part by inserting the receiving part into the holding part (403).

According to sub step (401a), an injection moulding device is used for moulding the receiving part, which comprises a first mould form and a second mould form, which can be closed to define the negative contour of the receiving part, the receiving part, the first mould form and a second mould form being respectively configured such that the receiving part does not require an undercut portion.

1. Snap-in mounting for mounting a top cover onto the engine of a motor vehicle, comprising a female part including a receiving part and a holding part, wherein the receiving part is configured to receive the end of a male part by a snap-in connection the holding part is configured for holding the receiving part, wherein the holding part is adapted to be fixed to the top covers bottom side, which faces the engine of a motor vehicle when mounted, characterized in that the receiving part is moulded from a polymer material containing at least a thermoplast.

2. Snap-in mounting according to claim 1, wherein the receiving part and the holding part are separate parts, wherein the holding part has a sliding portion, which is adapted to allow for a relative displacement of thereceiving part and the holding part by a sliding motion.

3. Snap-in mounting according to claim 1, wherein the receiving part has a ball receiving portion and has at least one click wall, which is arranged and shaped to be displaced by being elastically bended under the force provided by inserting the ball-shaped end of the male part into the ball receiving portion, such that the at least one click wall supports and retains the male part at the receiving part by engaging an undercut provided at the ball-shaped end of the male part.

4. Snap-in mounting according to claim 1, wherein the receiving part has a funnel-shaped receiving portion, which includes a funnel-shaped inner volume, and a ball receiving portion, which includes a ball-receiving inner volume, which is preferably substantially ball-shaped, wherein the receiving part has multiple rib portions, and preferably at least one of the funnel-shaped inner volume, and the ball-receiving inner volume is defined by the surface of the multiple rib portions, which are facing the ball-receiving inner volume and/or preferably the funnel-shaped inner volume.

5. Snap-in mounting according to claim 4, wherein the ball-receiving portion has an opening, through which the ball-shaped end of the male part is inserted into the ball-receiving portion for providing coupling of the female part and the male part, and wherein the rib portions are aligned at least in part around the ball-shaped inner volume in a longitudinal direction, considering the ball-shaped inner volume having a south pole, which lies in the centre of the opening, and an opposing north pole, which are connected by a central linear axis running through both poles and by lines of longitude leading around the ball-shaped inner volume.

6. Snap-in mounting according to claim 5, wherein the ball-receiving inner surface of the ball-receiving portion is defined by a first set of rib portions, which defines at least a part of a first half of the ball-shaped inner volume, and by a second set of rib portions, which defines at least a part of the second half of the ball-shaped inner volume, considering the receiving part being divided by a virtual plane running through the centre of the ball-shaped inner volume.

7. Snap-in mounting according to claim 6, wherein the rib portions of the first set of rib portions and the rib portions of the second set of rib portions are respectively provided with a number N, wherein 2<=N<=10, and are arranged with an offset by a rotation to each other around the central axis, wherein the rotational shift preferably corresponds to an angle b=180°/N.

8. Snap-in mounting according to claim 7, wherein the rib portions of the first set of rib portions are formed to be lamellae which extend longitudinally in the direction from the equator of the spherical inner volume towards the north pole, while they are arranged self-supporting.

9. Snap-in mounting according to claim 1, wherein the thermoplast is chosen from the group of materials comprising polyamides, polyesters and polyolefines.

10. Snap-in mounting according to claim 1, wherein the polymer material is chosen such that the elastic modulus Et of the polymer material is taken from the group of preferred ranges including 0.11 GPa<Et<50 GPa, or 0.15 GPa<Et<20.00 GPa or 0.15 GPa<Et<5.00 GPa.

11. Snap-in mounting according to claim 1, wherein the receiving part consists of a first polymer material containing at least the thermoplast, and the holding portion part consists of a second polymer material, which contains the same thermoplast.

12. Mounting system comprising at least one snap-in mounting according to claim 1, which in particular already contains the female part according to claim 1, and comprising at least one male part having a ball-shaped end, which can be coupled to said female part by a snap-in connection.

13. Top cover for covering the engine of a motor vehicle, having a top side and a bottom side, wherein at least one snap-in mounting according to claim 1 is connected with the bottom side of the top cover, for mounting the top cover onto the engine of a motor vehicle.

14. Top cover according to claim 13 further comprising at least a carrier layer consisting of a consolidated fibrous material consisting of fibres and a binder in the form of a thermoplastic binder or a thermoset binder whereby the binder forms small binding points between the fibers to consolidate the fibrous material.

15. Top cover according to claim 14 whereby the fibres are at least one of thermoplastic fibers, preferably polyester fibers, preferably polyethylene-terephthalate (PET) or polybutylene terephthalate (PBT), natural fibers, preferably cotton or flax fibers, or mineral fibers, preferably glass-, carbon-, ceramic- or basalt fibers, or a mixture of such fibers.

16. Top cover part according to claim 15, whereby the thermoplastic binder is either a copolymer of polyester, or polyamide or whereby the thermoset binder is a resinous type preferably phenolic resin.

17. Top cover part according to claim 16 further comprising at least one acoustic absorbing layer, preferably a fibrous layer and or an open cell foam layer.

18. Top cover part according to claim 17, further comprising a film layer preferably pervious, between the structural layer and the acoustic absorbing layer.

19. Top cover part according to claim 18 further comprising at least one deco layer preferably one of a textile fabric, like a knitted fabric or a woven fabric, a nonwoven fabric or a film layer, like a thermoplastic polyurethane film layer optionally perforated, or a combination of such layers.

20. Method of producing the snap-in mounting according claim 1, providing at least the steps of: forming the receiving part of the snap-in mounting by injection moulding, and providing the holding part of the snap-in mounting, preferably: assembling the receiving part and the holding part by inserting the receiving part into the holding part.

21. Method according to claim 14, wherein a moulding device is used for moulding the receiving part, which comprises a first mould form and a second mould form, which can be closed to define the negative contour of the receiving part, wherein the receiving part, the first mould form and a second mould form are respectively configured such that the receiving part does not require an undercut portion.

22. Moulding device for moulding at least the receiving part of the snap-in mounting according to claim 1 wherein the injection moulding device comprises a first mould form and a second mould form, which can be closed to define the negative contour of the receiving part, wherein, preferably, the receiving part, the first mould form and a second mould form are respectively configured such that the receiving part does not require an undercut portion.
